(19) United States
(12) Patent Application Publication
(10) Pub. No.: US 2007/0293134 A1
(43) Pub. Date: Dec. 20, 2007

(54) Defroster duct

(75) Inventors: Tadashi Shimada, Sano-shi (JP); Hiroshi Kishi, Tochigi-shi (JP); Ryoichi Tochigi, Tochigi-shi (JP)

Correspondence Address: FOLEY AND LARDNER LLP;SUITE 500, 3000 K STREET NW, WASHINGTON, DC, 20007, US

(73) Assignee: CALSONIC KANSEI CORPORATION

(21) Appl. No.: 11/798,636

(22) Filed: May 15, 2007

(30) Foreign Application Priority Data
May 16, 2006 (JP) 2006-136781

(51) Int. Cl. B60S 1/54

(52) U.S. Cl. 454/121

(57) ABSTRACT

To provide a defroster duct comprising a duct body defining an air passage which has an inlet in an upstream end of the air passage, and an outlet in a downstream end of the air passage, the duct body configured to flow an air toward a windshield of a vehicle via the outlet, wherein an inner face of the duct body defining a first face and a second face opposite to the first face, wherein the duct body including a wind direction-changing rib extending from the first face toward the second face and having no contact with the second face.

### CROSS REFERENCE TO RELATED APPLICATIONS

This application is based upon and claims the benefit of priority from prior Japanese Patent Application P2006-136781 filed on May 16, 2006; the entire contents of which are incorporated by reference herein.

### BACKGROUND OF THE INVENTION

The present invention relates to a defroster duct from which conditioned air flows out toward a windshield.

Japanese Patent Application Laid-open No. H10-236153 discloses a conventional defroster duct similar to the present invention. As shown in FIG. 1, a defroster duct 100 includes a duct body 101 in which air passages 101c are formed. One ends of the air passages 101c are formed with inlets 101a and the other ends of the air passages 101c are formed with outlets 101b. The defroster duct 100 also includes a pair of left and right wind direction-changing ribs 102 which branch the air passages 101c of the duct body 101. An air conditioning unit 103 is connected to the inlets 101a, and conditioned air of desired temperature is introduced from the air conditioning unit 103. The outlets 101b are opened at an instrument panel (not shown) of a lower end of the windshield (not shown).

The pair of left and right wind direction-changing ribs 102 are straight in shape, and are inclined such that a distance therebetween is gradually increased. The wind direction-changing ribs 102 completely divide the air passages 101c into three.

According to the conventional example, the wind direction-changing ribs 102 guide the conditioned air introduced from the inlets 101a in such a manner that the conditioned air is spread in a form of a fan as a whole. Thus, a blowing distribution from the outlet 101b can be made wide.

However, according to the conventional defroster duct 100, since the wind direction-changing ribs 102 completely divide the air passages 101c, there is a possibility that a no-wind region is generated around the wind direction-changing ribs 102, and as a result, wind velocity is reduced. Therefore, although the blowing distribution is wide, a range far from the outlet 101b can not be covered.

Further, since the wind directions of all of the conditioned air are the same, a so-called valley of blowing out air flow is generated downstream of the wind direction-changing ribs 102. Thus, although the blowing distribution is wide, the blowing distribution becomes partially uneven.

### SUMMARY OF THE INVENTION

It is an object of the present invention to provide a defroster duct capable of covering a range where the blowing out flow from the outlet is wide and far from the outlet, and capable of achieving even blowing distribution.

An aspect of the present invention provides a defroster duct comprising a duct body defining an air passage which has an inlet in an upstream end of the air passage, and an outlet in a downstream end of the air passage, the duct body configured to flow an air toward a windshield of a vehicle via the outlet, wherein an inner face of the duct body defining a first face and a second face opposite to the first face, wherein the duct body including a wind direction-changing rib extending from the first face toward the second face and having no contact with the second face.

### BRIEF DESCRIPTION OF THE DRAWINGS

FIG. 1 is a perspective view of a conventional defroster duct;

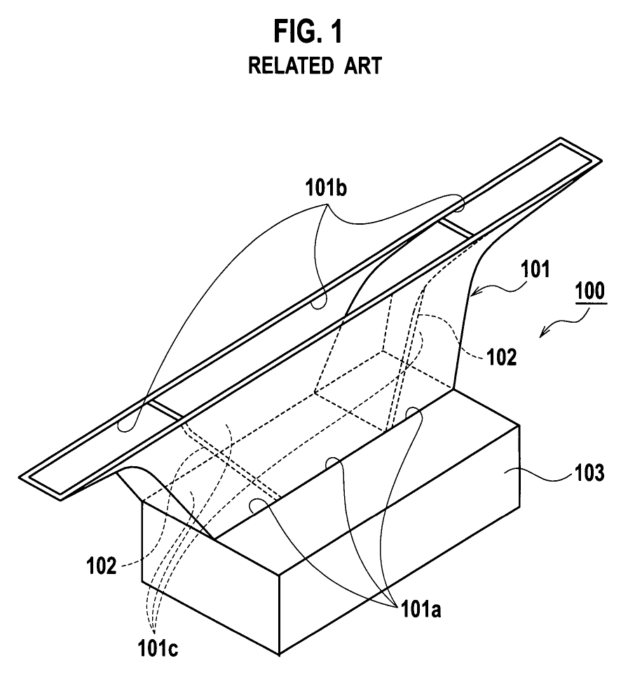

FIG. 2 is a schematic diagram of a vehicle and shows an embodiment of the present invention;

FIG. 3 is a diagram of an instrument panel as viewed from a driver and shows the embodiment;

FIG. 4 is a front view of a defroster duct and a windshield and shows the embodiment;

FIG. 5 is a sectional view taken along the line V-V in FIG. 4 and shows the embodiment;

FIG. 6 is an enlarged view of a wind direction-changing rib and shows the embodiment;

FIG. 7 is an enlarged view of a portion VII in FIG. 5 and shows the embodiment;

FIG. 8 is a diagram of a wind direction-changing flow and a rib-crossing flow and shows the embodiment; and

FIG. 9 is a front view of a defroster duct and a windshield according to another embodiment of the present invention.

### DETAILED DESCRIPTION OF THE PREFERRED EMBODIMENTS

Embodiments of the present invention are explained below with reference to the drawings.

### First Embodiment

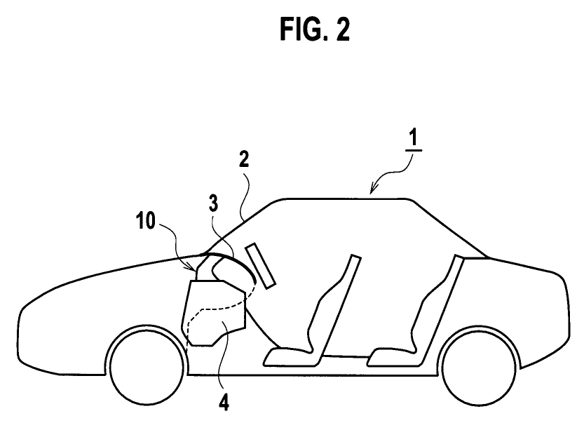

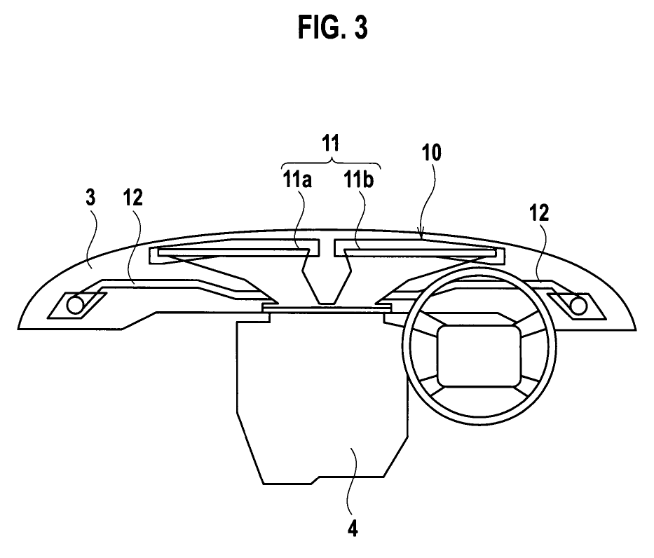

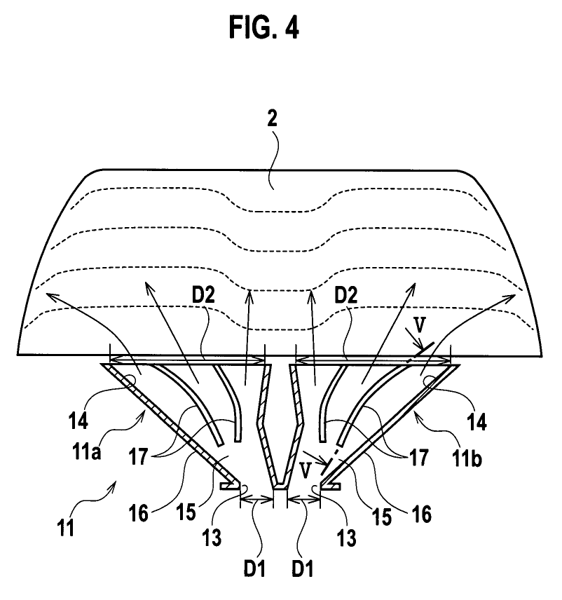

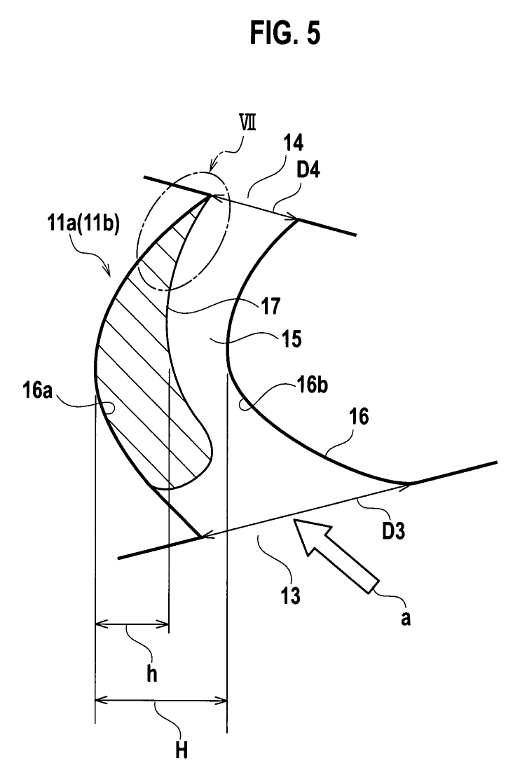

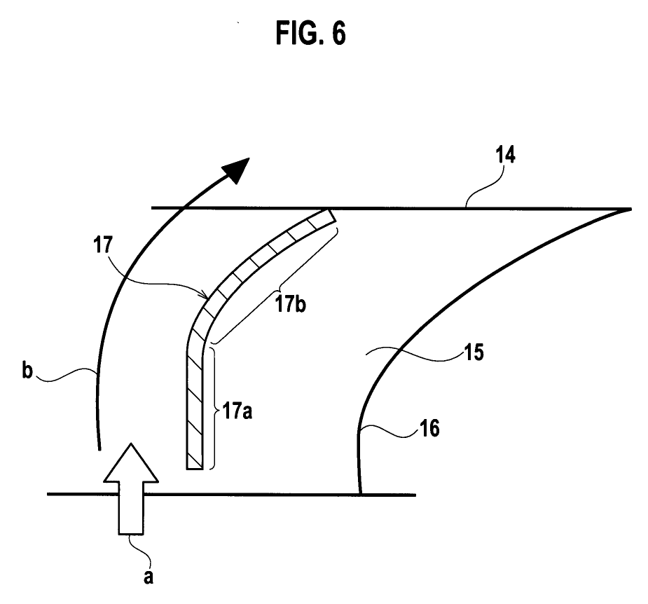

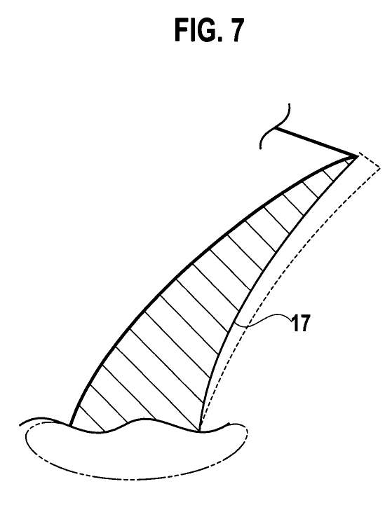

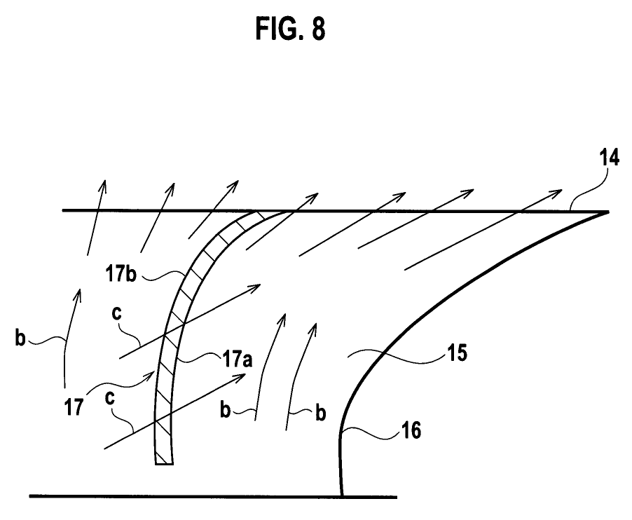

FIGS. 2 to 8 show a first embodiment of the present invention, where FIG. 2 is a schematic diagram of a vehicle, FIG. 3 is a diagram of an instrument panel as viewed from a driver, FIG. 4 is a front view of a defroster duct and a windshield, FIG. 5 is a sectional view taken along the line V-V in FIG. 4, FIG. 6 is an enlarged view of a wind direction-changing rib, FIG. 7 is an enlarged view of a portion VII in FIG. 5, and FIG. 8 is a diagram of a wind direction-changing flow and a rib-crossing flow.

As shown in FIG. 2, a front portion of a passenger room of a vehicle 1 is covered with a windshield 2. An instrument panel 3 is disposed on a vehicle side of a lower end of the windshield 2. An air conditioning unit 4 is disposed below the instrument panel 3. The air conditioning unit 4 generates conditioned air of a predetermined temperature, and the generated conditioned air is sent out into the passenger room through various ducts such as a defroster duct 10.

As shown in FIG. 3, the defroster duct 10 includes a front duct portion 11 and side duct portions 12. The front duct portion 11 clears the fogging of the windshield 2, and the side duct portions 12 clear the fogging on the side of the side glass. A structure of the front duct portion 11 will be explained below.

As shown in FIG. 4, the front duct portion 11 includes a pair of left and right branch duct portions 11a and 11b due to other car-mounted part disposing spaces. Each of the branch duct portions 11a and 11b includes a duct body 16 provided therein with an air passage 15, and a plurality of wind direction-changing ribs 17 provided in the air passage 15 of the duct body 16. One end of the air passage 15 is provided with an inlet 13, and the other end of the air passage 15 is provided with an outlet 14.

An air conditioning unit 4 is connected to the inlet 13, and conditioned air having a desired temperature is introduced by the air conditioning unit 4. The outlet 14 opens at the instrument panel 3 (shown in FIGS. 2 and 3) at a lower end of the windshield 2.

Each of the inlets 13 is formed into a narrow size D1 (shown in FIG. 4) in the widthwise direction of the vehicle, and the outlet 14 is formed into a wide size D2 (shown in FIG. 4) in the widthwise direction of the vehicle due to other car-mounted part disposing spaces. The inlet 13 is formed into a wide size (shown in FIG. 5) in the longitudinal direction of the vehicle, and the outlet 14 is formed into a narrow size D4 (shown in FIG. 5) in the longitudinal direction of the vehicle. A cross-sectional area of the inlet 13 and a cross-sectional area of the outlet 14 are substantially the same with each other.

The two wind direction-changing ribs 17 are disposed at two locations in the air passages 15. As shown in FIG. 5, if an inner surface of the duct body 16 which forms the air passage 15 and along which the conditioned air a mainly flows is defined as a first surface 16a, and an inner surface of the duct body 16 which is opposed to the first surface 16a is defined as a second surface 16b, each wind direction-changing rib 17 is set such that the wind direction-changing rib 17 projects from the first surface 16a toward the second surface 16b but does not reach the second surface 16b. If a height of the air passage 15 is defined as H, a height h of the wind direction-changing rib 17 is set in a range of ⅓·H to ⅔·H.

As shown in FIG. 6, each wind direction-changing rib 17 includes a straight rib portion 17a extending along a direction of the main flow of the conditioned air a introduced from the inlet 13, and a curved rib portion 17b which is continuous with the downstream end of the straight rib portion 17a and gradually bent or curved in a desired direction with respect to the direction of the main flow of the conditioned air a.

As shown in FIG. 7, a height of the downstream end of the wind direction-changing rib 17 is smoothly reduced toward the downstream, and the height of the most downstream end is zero. That is, if the downstream end of the wind direction-changing rib 17 is formed as indicated by the broken line in FIG. 7, a step is formed at a location of the most downstream end, however, the step is not actually formed.

In the configuration described above, since each wind direction-changing rib 17 guides the conditioned air a introduced from the inlet 13 such that the entire conditioned air spreads, the blowing distribution from the outlet 14 becomes wide.

The flow of the conditioned air a in the air passage 15 will be explained in more detail. As shown in FIGS. 5 and 8, the main flow of the conditioned air a introduced into the air passage 15 travels near the first surface 16a, the main flow becomes a wind direction-changing flow b which travels while changing the wind direction by the wind direction-changing rib 17, and conditioned air a other than the main flow travels near the second surface 16b and thus becomes a rib-crossing flow c which travels without changing the wind direction by the wind direction-changing rib 17. Therefore, no-wind region is not generated around the wind direction-changing rib 17 and as a result, the air travels without reducing the wind velocity. Further, since air flows having different traveling directions, i.e., the wind direction-changing flow b and the rib-crossing flow c flow out from the outlet 14, no-wind region, i.e., a so-called valley of blowing out air flow is not generated downstream of the wind direction-changing rib 17. From the above reason, the blowing out wind from the outlet 14 has a wide range and a range far from the outlet 14 can be covered, and even blowing distribution can be achieved. In FIG. 4, wind velocity regions such as blowing out wind are indicated by broken lines, and the broken line at a position above a point shows an effective wind velocity value reaching region.

Since the wind direction-changing rib 17 does not completely divide the air passage 15, the blowing air resistance of the wind direction-changing rib 17 becomes small and thus, it is possible to prevent the wind velocity from being reduced.

In the present embodiment, each the wind direction-changing rib 17 includes the straight rib portion 17a extending along the direction of the main flow of the conditioned air a, and the curved rib portion 17b which is continuous with the downstream end of the straight rib portion 17a and gradually bent or curved in the desired direction with respect to the direction of the main flow of the conditioned air a. Therefore, the main flow of the conditioned air a travels while being guided by the straight rib portion 17a and then, its wind direction is smoothly changed by the curved rib portion 17b. Thus, a noise caused by peeling off of the conditioned air generated when the wind direction of the conditioned air is abruptly changed is not generated.

In the present embodiment, the height of the downstream end of the wind direction-changing rib 17 is smoothly reduced toward downstream, and the height of the most downstream end becomes zero. Therefore, since separation of wind is not generated downstream of the wind direction-changing rib, it is possible to reliably prevent no-wind region (that is, a valley of blowing out air flow) from being generated in the blowing out air.

In the present embodiment, the inlet 13 is narrow in width in a widthwise direction of a vehicle, the outlet 14 is wide in the widthwise direction of the vehicle, the inlet 13 is wide in a longitudinal direction of the vehicle, the outlet 14 is narrow in the longitudinal direction of the vehicle, a cross-sectional area of the inlet 13 is substantially equal to a cross-sectional area of the outlet 14. Therefore, it is possible to prevent the flowing velocity of the conditioned air from being reduced in the air passage 15 as small as possible. Thus, the blowing out speed of the conditioned air can be maintained at a predetermined speed. Thus, it is possible to prevent a fogging-clearing range of the windshield 2 from becoming narrow and to prevent the fogging-clearing speed from being reduced.

### Second Embodiment

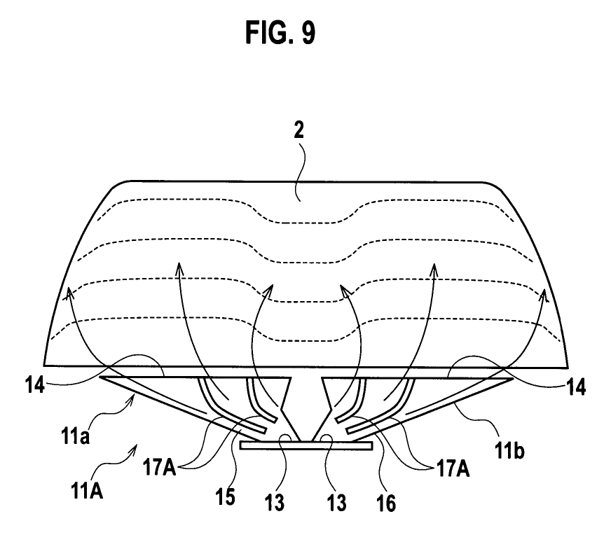

FIG. 9 is a front view of a defroster duct and a windshield according to second embodiment of the present invention. The front duct portion 11 of the previous embodiment is a vertically long. A front duct 11A shown in FIG. 9 is a laterally long and this point is different. With this different point, a wind direction-changing rib 17A is set such that a wind direction of conditioned air is changed in a direction in which the conditioned air is prevented from spreading. Other structures are identical to that of the previous embodiment, and therefore redundant explanations thereof will be omitted. Also with the present embodiment, the same effect as that of the previous embodiment can be obtained.

While the embodiments of the present invention have been described above, the invention is not limited to the above embodiments and changes and modifications can be made within the scope of the gist of the present invention.

For example, each of the wind direction-changing ribs 17 and 17A according to the above embodiments includes the straight rib portion 17a and the curved rib portion 17b, but a portion of the wind direction-changing rib where it is unnecessary to change the wind direction or it is unnecessary to largely change the wind direction may comprise only a straight portion.

What is claimed is:

1. A defroster duct comprising
a duct body defining an air passage which has an inlet in an upstream end of the air passage, and an outlet in a downstream end of the air passage, the duct body configured to flow an air toward a windshield of a vehicle via the outlet,
wherein an inner face of the duct body defining a first face and a second face opposite to the first face,
wherein the duct body including a wind direction-changing rib extending from the first face toward the second face and having no contact with the second face.

2. The defroster duct according to claim 1, wherein
the wind direction-changing rib comprises a straight rib portion which extends along a direction in which an introduced conditioned air mainly flows, and
a curved rib portion which is continuous with a downstream end of the straight rib portion and which is gradually curved in a desired direction with respect to the direction along which the conditioned air mainly flows.

3. The defroster duct according to claim 1, wherein
a height of a downstream end of the wind direction-changing rib is smoothly reduced toward downstream, and the height of the most downstream end becomes zero.

4. The defroster duct according to claim 1, wherein
the inlet is narrow in width in a widthwise direction of a vehicle, the outlet is wide in the widthwise direction of the vehicle, the inlet is wide in a longitudinal direction of the vehicle, the outlet is narrow in the longitudinal direction of the vehicle, a cross-sectional area of the inlet is substantially equal to a cross-sectional area of the outlet.

5. The defroster duct according to claim 2, wherein
a height of a downstream end of the wind direction-changing rib is smoothly reduced toward downstream, and the height of the most downstream end becomes zero.

6. The defroster duct according to claim 2, wherein
the inlet is narrow in width in a widthwise direction of a vehicle, the outlet is wide in the widthwise direction of the vehicle, the inlet is wide in a longitudinal direction of the vehicle, the outlet is narrow in the longitudinal direction of the vehicle, a cross-sectional area of the inlet is substantially equal to a cross-sectional area of the outlet.

7. The defroster duct according to claim 3, wherein
the inlet is narrow in width in a widthwise direction of a vehicle, the outlet is wide in the widthwise direction of the vehicle, the inlet is wide in a longitudinal direction of the vehicle, the outlet is narrow in the longitudinal direction of the vehicle, a cross-sectional area of the inlet is substantially equal to a cross-sectional area of the outlet.

8. The defroster duct according to claim 5, wherein
the inlet is narrow in width in a widthwise direction of a vehicle, the outlet is wide in the widthwise direction of the vehicle, the inlet is wide in a longitudinal direction of the vehicle, the outlet is narrow in the longitudinal direction of the vehicle, a cross-sectional area of the inlet is substantially equal to a cross-sectional area of the outlet.
